(19) United States
(12) Patent Application Publication
(10) Pub. No.: US 2019/0025793 A1
(43) Pub. Date: Jan. 24, 2019

(54) METHOD AND APPARATUS FOR CALIBRATING A SCANNING PROBE

(71) Applicant: RENISHAW PLC, Wotton-under-Edge, Gloucestershire (GB)

(72) Inventor: John Charles OULD, Backwell (GB)

(73) Assignee: RENISHAW PLC, Wotton-under-Edge, Gloucestershire (GB)

(21) Appl. No.: 16/070,998

(22) PCT Filed: Feb. 22, 2017
(86) PCT No.: PCT/GB2017/050450

§ 371 Date: Jul. 18, 2018

(30) Foreign Application Priority Data
Feb. 29, 2016 (GB) 1603496.9

(51) Int. Cl. G05B 19/401; G01B 21/04

(52) U.S. Cl. CPC G05B 19/401; G05B 2219/37069; G05B 2219/37008; G01B 21/042

(57) ABSTRACT

A method for setting a null position of a scanning probe mounted to the rotatable spindle of a machine tool. This method may be performed as part of a probe qualification process. The method includes setting the null position using probe measurement data collected by the scanning probe when mounted to the spindle. In one embodiment, a stylus tip of the scanning probe may be located in a conical recess whilst the probe measurement data is collected. The set null position is arranged to be away from the rest position of the scanning probe and to substantially coincide with the axis of rotation of the spindle. The need to measure and use a probe offset value in subsequent measurement cycles can thus be avoided.

The present invention relates to configuring scanning probes for measurement purposes and in particular to a method of setting the null position of a scanning probe mounted to the rotatable spindle of a machine tool.

Computer Numerically Controlled (CNC) machine tools are widely used in manufacturing industry to cut parts. Such machine tools can also be arranged to carry a measurement probe that allows parts to be measured for set-up or inspection purposes. In particular, it is known for machine tools to incorporate so-called touch trigger measurement probes that have a deflectable stylus. Such touch trigger probes are typically loaded into the spindle of the machine tool whenever measurements are to be taken and issue a trigger signal to the machine tool when the stylus is deflected due to contact with an object. The machine tool thus moves the measurement probe towards and away from discrete points on the surface of an object in accordance with one or more pre-programmed measurement cycles and stores information on the position of the measurement probe relative to the surface of the object at the instant the trigger signal is issued. This allows, with appropriate calibration, the position of points on the surface of the object to be measured.

One of the calibration procedures that is necessary before taking any touch trigger measurements is probe system qualification. The need to perform such a probe qualification process to establish the parameters of the probing system is defined in ISO standard 230-10:2011 and such a process usually comprises calculating offsets, length and the effective radius of the touch trigger probe (sometimes in multiple directions). One part of a known qualification process comprises a mechanical clocking step in which a dial test indicator (DTI) is placed against the tip of the probe stylus whilst the spindle holding the touch trigger probe is slowly rotated by hand. Adjustment screws are then used to mechanically centre the stylus tip on the spindle centre line (i.e. the axis of rotation of the spindle). This mechanical clocking step can ensure the centre of the stylus tip lies within a few tens of microns of the spindle centre line, but this is typically not sufficiently accurate for measurement.

A subsequent measurement process is often then conducted to establish the so-called probe offset, which is the offset in position between the centre of the stylus tip and the spindle centre line. The measured probe offset values can then be incorporated as corrections into any measurement cycles run by the machine tool.

Recently, a robust suspended scanning probe for use on a CNC machine tool has become available; i.e. the SPRINT probing system which is available from Renishaw plc, Wotton-Under-Edge, Gloucestershire, UK. Such a scanning probe is also described in U.S. Pat. No. 6,683,780. A suspended scanning probe of this type comprises a stylus that is held in a rest position by a spring arrangement. During probe qualification an on-centre adjustment procedure (e.g. a mechanical clocking process) similar to that used with touch trigger probes is performed. One or more transducers are provided within the suspended scanning probe for measuring the magnitude and direction of stylus deflection in a local (probe) coordinate system. However, the stylus of such a suspended scanning probe doesn't return to a precisely defined rest position, but instead returns to somewhere within a “return to zero zone”. During qualification, an adopted stylus rest position (which is arbitrarily located within the return to zero zone) is thus set as the probe null position against which all subsequent probe deflections are measured.

The use of the above qualification procedure has been found by the present inventors to have a number of disadvantages. For example, the measurement software running on the CNC needs to account for the probe offset (i.e. the positional deviation of the defined null position from the spindle centre line) in any measurement cycles. This can slow down the cycle time and may even lead to small positional corrections being implemented that cause machine juddering and thereby introduce measurement inaccuracies.

According to a first aspect of the present invention, there is provided a method for setting a null position of a scanning probe mounted to a rotatable spindle of a machine tool, the method comprising the step of setting the null position using probe measurement data collected by the scanning probe when mounted to the spindle, wherein the set null position is arranged to be away from the rest position of the scanning probe and to substantially coincide with the axis of rotation of the spindle.

The present invention thus comprises a method for setting the null position of a scanning probe, which may be performed as part of a probe qualification process. As would be understood by a person skilled in the art, a rest position of a scanning probe is a defined physical position relative to the probe; e.g. a position adopted by the tip of the stylus of a contact scanning probe when no deflecting force is applied to the stylus. It would be further understood that the null position is a home or zero position for measurements taken by the scanning probe in its local coordinate system. For example, a scanning probe with a deflectable stylus may output probe measurement data that describes the amount of stylus deflection along three mutually orthogonal axes (e.g. along a, b, and c Cartesian axes). In such an example, the null position of the probe could be defined as the origin of the local coordinate system (i.e. a=0, b=0, c=0) and all probe measurement data output by the probe may be described as local stylus deflections relative to this null position (e.g. using sets of a, b, and c coordinate values).

The process of qualifying a suspended scanning probe having a stylus has, prior to the present invention, simply involved performing a mechanical clocking process (in a similar manner to the process used with touch trigger probes) to try to align the stylus tip (i.e. the stylus tip in the rest position) with the spindle centre line. An arbitrary rest position adopted by the stylus (i.e. a rest position which may be located at any arbitrary position within the return to zero zone) is then defined to be the “null” position for that qualification. The defined null position of the scanning probe is then used as a reference point (i.e. a zero point or home position) in an analogous way to the rest position of a touch trigger probe. In other words, the null position set during qualification is used as the origin of the local probe coordinate system (e.g. the a=0, b=0, c=0 position) and all subsequent deflection measurements made by the probe transducers, along with any trigger or skip signals that might be generated in the touch trigger mode described below, are defined relative to that null position.

This prior art technique allows the null position to be set to within several tens of microns of the axis of rotation of the spindle. This level of accuracy is, however, rarely sufficient where accurate metrology is required. The prior art technique thus meant there was always a so-called “probe offset” (i.e. a spatial separation) between the null position of the scanning probe and the spindle rotation axis (i.e. in the same way such a probe offset occurs when using a touch trigger probe). It was therefore necessary in all but the lowest accuracy measurement procedures to also perform additional steps to remove the effect of the probe offset. These additional steps could include, for example, calculating a probe offset value (e.g. a probe offset vector) that describes the offset of the probe null position from the spindle axis of rotation and then using that probe offset value in various measurement routines and calculations performed by the machine tool. Alternatively, the effects of the probe offset could be avoided by arranging for stylus deflection to always occur in the same direction relative to the probe body or by taking the average of two measurements of each point on the surface of the object with the probe rotated through 180° (i.e. so that the effects of any probe offset cancels out). These additional steps have been found to add complexity to measurement routines and/or add to the cycle time for a particular measurement.

The present invention comprises setting the null position using probe measurement data collected by the scanning probe when mounted to the spindle. In particular, the set null position is arranged to be away from the rest position of the scanning probe and to substantially coincide with the axis of rotation of the spindle. In other words, the present inventors have realised that the set null position for a probe having a deflectable stylus (e.g. the stylus tip position for which the probe outputs a, b, and c are all zero) can be set to be different to the physical rest position adopted by the stylus. This null position may be stored within the probing system (e.g. within a probe interface associated with the scanning probe) and all probe measurement data generated by the scanning probe system will thereafter be defined relative to a null position that lies on the spindle axis of rotation. In this manner, the scanning probe system itself is configured so that the probe offset effects that are associated with the prior art nulling methods are eliminated or reduced to such an extent that no further corrective action is required (e.g. there is no need to measure any kind of probe offset for use in subsequent measurement cycles that are run by the machine tool controller). This reduces the complexity of measurement routines and/or reduces the cycle time for a particular measurement.

Although the method may be used with non-contact scanning probes (e.g. inductive probes, capacitive probes, optical scanning probes etc), the scanning probe is preferably a contact scanning probe (i.e. the scanning probe makes physical contact with the object being measured). The scanning probe preferably comprises a probe body. An elongated stylus may extend from the probe body. The stylus may comprise a workpiece contacting tip, for example at its distal end. The stylus may also comprise one or more additional stylus tips. Preferably, the stylus tip comprises a ball or a sphere. For example, a ruby or zirconia sphere may provide a suitable stylus tip. The long axis of the stylus preferably extends in a direction substantially parallel to the spindle axis of rotation (i.e. the spindle centre line). The spindle in which the scanning probe is mounted is preferably the rotatable tool holding spindle of the machine tool.

The scanning probe may measure stylus deflection in any suitable manner. Advantageously, the scanning probe comprises one or more transducers that measure deflection of the stylus. The one or more transducers may be located within the probe body. Any type of transducer may be provided; for example, capacitive, optical, magnetic, or inductive transducer arrangements may be used. The scanning probe preferably outputs probe measurement data describing deflection of the stylus. The probe measurement data may be provided in any suitable format; e.g. as a stream of probe data values or as one or more varying analogue or digital outputs. The probe measurement data may comprise a series of stylus deflection coordinate values (e.g. a,b,c, values) defined in the probe coordinate system. The scanning probe system (i.e. a system comprising the scanning probe and any associated probe interface) may also analyse probe measurement data internally and generate a trigger signal if the stylus deflection exceeds a certain threshold. As explained above, the use of probe measurement data acquired using the scanning probe (e.g. data output from the transducers of the scanning probe) allows the null position of the scanning probe to be set to coincide with the axis of rotation of the spindle. Such probe measurement data may be collected with the stylus deflected into a plurality of different positions. A variety of specific methods that allow the null position to be set in this manner are described below.

The method may be used to set the null position in any type of contact scanning probe. Advantageously, the scanning probe is a suspended scanning probe. In such a suspended scanning probe the stylus is attached to the probe body via a suspension mechanism that comprises a plurality of counteracting spring elements. These spring elements suspend the stylus in a floating rest position in the absence of an externally applied force. The spring elements also allow movement of the stylus away from the floating rest position when an external force is applied to the stylus. In such a probe, the stylus is not mechanically constrained to adopt a very accurately defined rest position when a stylus deflecting force is removed, but instead returns to a non-repeatable rest position within a certain “return to zero region”. It is preferred that the spindle centre line (and hence null position) lie within the return to zero region of the suspended scanning probe.

In a preferred embodiment, the step of setting the null measurement position comprises collecting probe measurement data (e.g. a,b,c, coordinates output by the scanning probe) whilst the stylus tip is in contact with an artefact that constrains translation of the tip but allows rotation of the tip. For a three-dimensional measurement, the artefact thus keeps the tip of the stylus (e.g. the centre of a spherical tip) in the same location relative to the bed of the machine tool. Although translation of the stylus tip is prevented, the artefact still allows rotation of the stylus tip. A variety of artefacts may be used. For example, the artefact may comprise a conical recess. The artefact may alternatively be formed from three balls (e.g. three balls spaced apart in a triangular arrangement with the stylus tip being received in the centre of the triangle) or it may be a corner cube.

Advantageously, the spindle is rotated whilst translation of the stylus tip is constrained by the calibration feature. In this manner, the stylus tip does not move position whilst the spindle and the scanning probe carried by the spindle are rotated. The rotation of the spindle does, however, alter the positon of the probe body relative to the artefact and hence the amount of stylus deflection changes during rotation. Probe measurement data may thus be collected by the scanning probe that describes deflection of the stylus at a plurality of different spindle rotational positions. The spindle may be rotated by less than one full rotation. Preferably, one or more complete rotations of the spindle may be performed. It is preferred that the location in which the stylus tip is retained is very slightly offset from the spindle centre line; this is simply to ensure the magnitude of stylus deflection is sufficient to be analysed.

Preferably, the probe measurement data is analysed to establish a positional difference between the spindle axis of rotation and a preliminary null position (e.g. an arbitrary null position set after a mechanical clocking step) used by the scanning probe when collecting the probe measurement data. The null position of the present invention may thus be set by applying the positional difference that is established by the analysis step to the preliminary null position. The present invention thus permits the null position to be set with a higher accuracy than is possible using a mechanical clocking process, although such a mechanical clocking technique may be usefully performed to obtain rough initial mechanical alignment of the rest position and the spindle centre line (e.g. to obtain a preliminary null position).

As an alternative to the immediately preceding method, the method may comprise a step of locating an artefact on the bed of the machine tool such that it lies on the axis of rotation of the spindle. The location of the artefact may be set in this manner using a clocking procedure. The scanning probe may then be used to measure the positon of the artefact. The measured position of the artefact may then be used to set the null position of the scanning probe.

In the above examples, an initial step may be performed of mechanically adjusting a rest position of the scanning probe relative the spindle to approximately align the scanning probe rest position to the axis of rotation of the spindle. This may involve a mechanical clocking procedure of the type used in prior art techniques. For example, the mechanical adjustment may comprise using a dial test indicator when adjusting the position of the scanning probe. The rest position of the probe after the mechanical clocking step may then be set as a preliminary null position. The scanning probe may then output probe measurement data relative to the preliminary null position prior to the null position being set. The preliminary null position may be set within 100 μm, or within 50 μm or within 20 μm of the spindle centre line. The method of the present invention may then provide a fine adjustment of the null position so that it lies on the spindle centre line (e.g. to within 20 μm, more preferably to within 10 μm, more preferably to within 5 μm or more preferably to within 2 μm). The scanning probe system (e.g. the probe interface) then preferably stores the set null position internally in some manner. After the null position is set, the scanning probe system thereafter conveniently outputs all probe measurement data to the machine tool controller as deviations (e.g. stylus deflections) from the set null position. For example, the null position may be taken as the a=0, b=0, c=0 coordinates (i.e. origin) within the local probe co-ordinate system and the probe measurement data may then be output to the controller of the machine tool in real-time.

The method may also comprise the step of using the scanning probe in so-called touch trigger mode. Instead of outputting a stream of position measurements (e.g. a, b c, coordinates) a step may be performed of generating a trigger signal when the measurement data collected by the scanning probe exceeds a threshold. For example, the trigger signal may be issued when stylus deflection exceeds a certain deflection threshold. The threshold used is conveniently based on deviation from the set null position. In other words, the set null position may also be used as the basis for touch trigger measurements taken using the scanning probe (thereby avoiding the need to calculate probe offsets etc). The trigger signal may be fed into the skip input of the machine tool, in the same manner as the trigger signal from a touch trigger probe. These touch trigger measurements may be used for part set-up or surface finding purposes. The touch trigger measurements may conveniently be taken prior to a step of collecting scanning data.

It should be noted that although a process for setting the null position is described herein it is likely that other calibration procedures will also need to be performed before measurements can be taken. Such further calibration procedures are not described herein for brevity. The null position may also be reset as and when required, for example when the stylus is replaced or when the probe installation is disturbed in some way (e.g. if a machine crash occurs). The present invention also extends to machine tool apparatus configured to implement the above method. Computer software that, when executed on a computer, implements the above method is also encompassed by the invention. Computer software in non-transitory form (e.g. stored on a carrier) is also envisaged.

According to a second aspect of the invention, there is provided apparatus comprising a scanning probe mounted to the rotatable spindle of a machine tool, the null position of the scanning probe being arranged to coincide with the axis of rotation of the spindle. The scanning probe may be provided as a part of a scanning probe system. The scanning probe system may also comprise a probe interface. The scanning probe system (e.g. the probe interface) preferably includes a memory for storing null position information. The apparatus may include a machine tool and/or an artefact as described above. The apparatus may also have any of the features described in connection with the first aspect of the present invention.

A method is also described herein for setting a null position of a measurement probe mounted to a machine tool. The measurement probe may be a scanning probe. The method may comprise the step of setting the null position using probe measurement data collected by the scanning probe when mounted to the spindle. The null position may be set to any convenient position. The null position may be set so as to substantially coincide with a machine tool axis. In a preferred embodiment, the machine tool axis may be the axis of rotation of a spindle (e.g. the spindle centre line). This may be the spindle on which the scanning probe is mounted. A scanning probe may also be provided that has a null position set according to the method outlined herein.

There is thus provided herein a method for setting a null position of a scanning probe having a deflectable stylus mounted to a rotatable spindle of a machine tool, the method comprising the step of setting the null position using probe measurement data collected by the scanning probe when mounted to the spindle. The measurement data may be collected using a plurality of different stylus deflections, wherein the set null position is arranged to substantially coincide with the axis of rotation of the spindle. In a further aspect, a method is provided for setting the null position of a measurement probe, such as a scanning probe. The null position is preferably set so as to be spaced apart from the rest position adopted by the probe during the setting process.

The invention will now be described, by way of example only, with reference to the accompanying drawings in which;

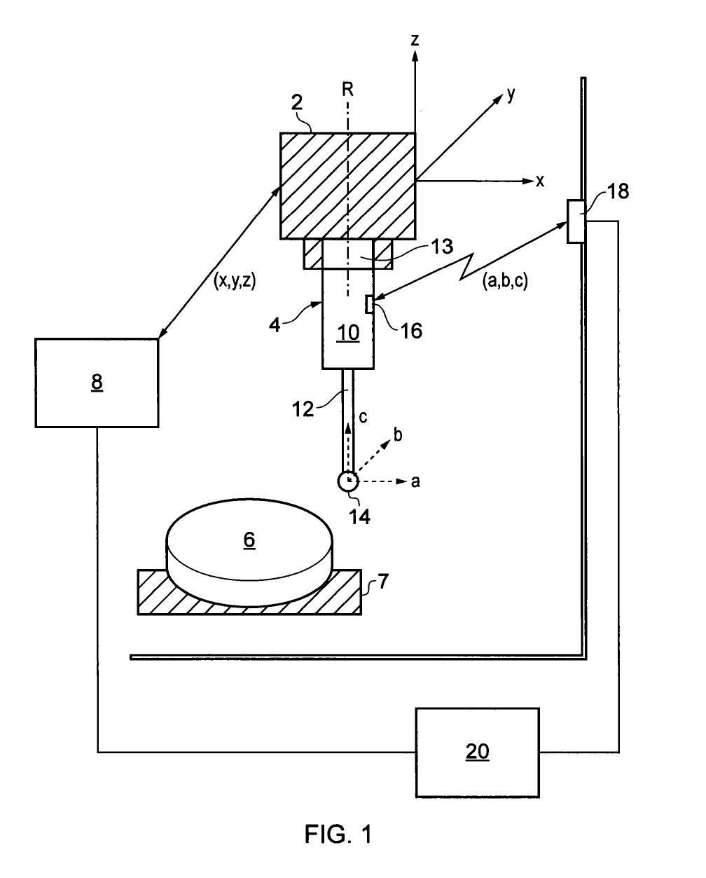

FIG. 1 illustrates a scanning probe mounted in the spindle of a machine tool,

FIG. 2 illustrates a touch trigger measurement probe,

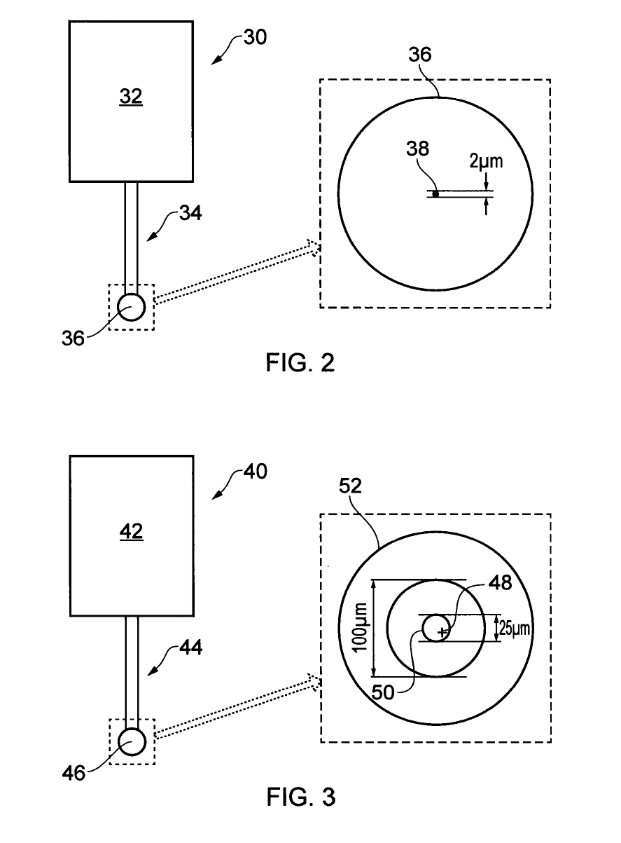

FIG. 3 illustrates a suspended scanning probe with the tip centre at the null position,

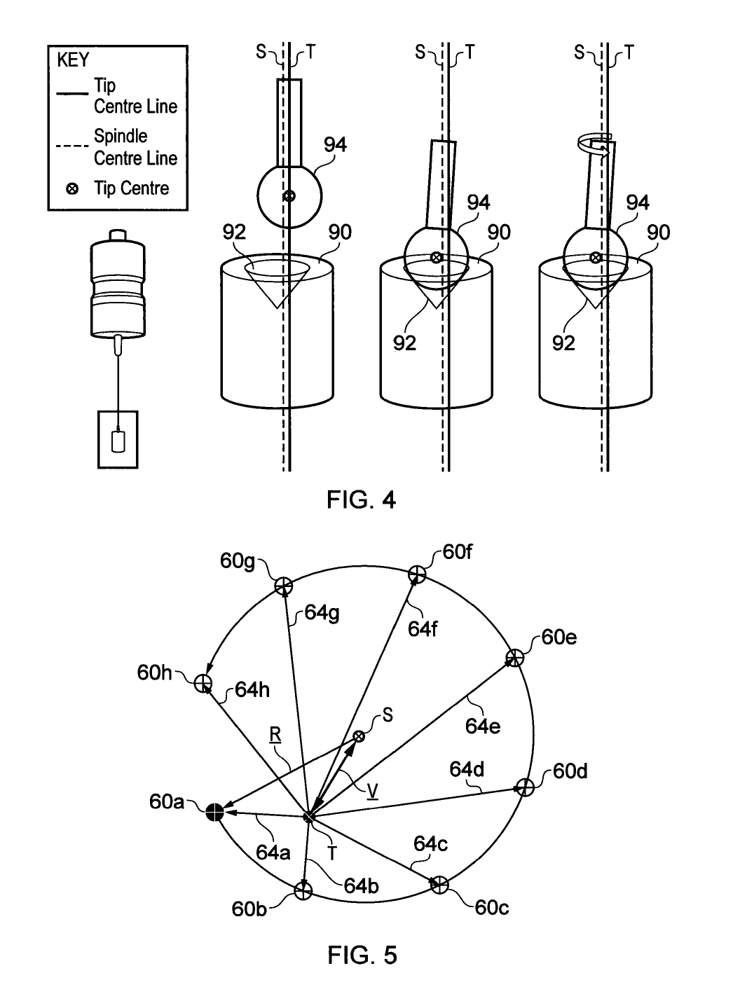

FIG. 4 shows locating a stylus tip in a conical recess, and

FIG. 5 illustrates the probe deflection that occurs when a spindle is rotated with the stylus tip of a suspended scanning probe held in a fixed position in a conical recess.

Referring to FIG. 1, a scanning probe 4 mounted in the tool holding spindle 2 of a machine tool is schematically illustrated. The spindle 2 can be moved along the X, Y and Z machine tool axes relative to an object 6 placed on a fixed base or bed 7 by various machine tool drive motors (not shown). The location of the spindle (in x, y and z) is also accurately measured using position encoders or the like (not shown). A numeric controller (NC) 8 outputs movement signals to the drive motors of the machine tool that cause the spindle 2 to move about in space and the NC 8 also receives positional information signals (x,y,z) from the position encoders. The spindle 2 is rotatable about a rotary axis R (commonly termed the spindle centre line) and a rotary encoder is also provided that measures the angle through which the spindle is rotated. In this known manner, accurate servo-controlled movement of the spindle 2 (and hence scanning probe 4) within the working space of the machine tool is provided.

The scanning probe 4 comprises a probe body 10 that is attached at its proximal end to a tapered shank 13. The spindle 2 of the machine tool comprises a corresponding recess for receiving the tapered shank 13. This arrangement allows multiple different shanks (e.g. for cutting tools, cutting accessories, measurement probes etc) to be automatically loaded into the spindle 2 as and when required. The spindle-shank tapered connection may be of any suitable standard; e.g. a HSK, NMTB etc standard arrangement may be used. The scanning probe 4 may be connected to its shank 13 by a mechanism (not shown) that allows the position of the probe body 10 relative to the shank to be adjusted (e.g. using adjustment screws) by a small amount. As explained below, this may be used to adjust the physical position of the scanning probe 4 relative to the axis of rotation R of the spindle 2.

The scanning probe 4 also comprises a workpiece contacting stylus 12 that protrudes from the distal end of the probe body 10. A stylus ball 14 is provided at the distal end or tip of the stylus 12. The scanning probe 4 includes one or more transducers that measure any deflections of the stylus tip 14 relative to the probe body 10; these measurement are made in the so-called probe geometry system (a,b,c). The probe 4 also comprises a transmitter/receiver portion 16 that communicates with a corresponding receiver/transmitter portion of a remote probe interface 18 located in the vicinity of the machine tool. Probe deflection (a,b,c) data can thus be output to the interface via a wireless communications link whenever required. For example, a continuous stream of probe deflection data (a,b,c, coordinate values) may be transmitted by the probe 4 to the probe interface 18.

Robust scanning probes for use in a harsh machine tool environment have only recently become available in the form of the SPRINT scanning probe system sold by Renishaw plc, Wotton-Under-Edge, UK. Prior to such scanning probe systems, it was widely known to mount a so-called touch trigger measurement probe to a machine tool. A touch trigger probe produces a “trigger” signal when the stylus tip is deflected by a certain amount. A touch trigger probe thus acts like a simple switch and provides a binary “on” or “off” output; i.e. a touch trigger probe outputs a “triggered” or “not-triggered” status that can be fed into the skip input of a machine tool controller. A touch trigger probe is thus quite different to the above described scanning probe that can output a series of stylus deflection values that describe the magnitude and direction of stylus deflection (e.g. a series of a,b,c, probe deflection measurements). There is, however, a need to take account of the position of the stylus tip position relative to the axis of rotation of the spindle when using a scanning probe or a touch trigger probe to acquire high accuracy measurements.

Referring to FIG. 2, there is shown a touch trigger probe 30 having a probe body 32 and a deflectable stylus 34 with a spherical workpiece contacting tip 36. The touch trigger probe 30 comprises a so-called “seated” stylus holding assembly. In other words, the stylus holding assembly comprises a biasing spring and complementary seating elements (e.g. balls and rollers) attached to the probe body 32 and stylus 34 respectively. The biasing spring forces the seating elements into engagement when no external force is applied to the stylus 34. This means the stylus 34 is held in an accurately defined rest position relative to the probe body 32 whenever an external stylus deflecting force is absent. For example, the OMP400 strain gauge based touch trigger probe sold by Renishaw plc has a stylus holding assembly that is mechanically constrained such that a “seated volume” is defined that extends about 2 μm. The inset to FIG. 2 shows the seated volume 38 of the touch trigger probe 30. A trigger signal is thus issued by the touch trigger probe if stylus deflection away from the rest position moves outside of the “seated volume”.

When a touch trigger probing system is first installed on a machine tool, or when a new stylus is fitted, the stylus is typically “clocked on centre”. This means that a linear displacement sensor (also termed a dial test indicator) is placed against the stylus tip 36 of the touch trigger probe 30 when it is mounted in the spindle of the machine tool. The machine tool spindle is then rotated by hand, noting the change in reading of the linear displacement sensor. One or more adjusting screws on the probe assembly allow the position of the touch trigger probe 30 to be adjusted relative to the spindle and are used to mechanically centre the stylus ball on the rotation centre of the machine spindle; i.e. so that the linear displacement sensor reading stays substantially constant as the machine spindle is rotated by hand.

The above described method of mechanically centring the stylus tip of a touch trigger probe is not perfect and typically there will be an error of up to a few tens of microns. The error vector is an error between the rest position of the stylus and the spindle centre line; this error is often called the “probe offset”.

Referring next to FIG. 3, a scanning probe 40 having a probe body 42 and a stylus 44 with a workpiece contacting tip 46 is shown. The scanning probe 40 is a so-called “suspended scanning probe” in which the stylus is suspended relative to the probe body using a stylus holding assembly that comprises an approximately balanced spring mechanism. In scanning probe 40, the stylus is thus suspended using a balanced spring system so that the stylus holding assembly is held by opposing spring forces in a rest position. Unlike a touch trigger probe of the type described above with reference to FIG. 2, a suspended scanning probe is not precisely mechanically constrained which means it has a non-negligible “return to zero error”. The return to zero error is the span of rest positions to which the stylus tip may return when it has been deflected and released. It should be noted that the return to zero error in this context refers to the error that occurs with the probe in the same orientation (i.e. not the significant difference in rest position that might occur with the probe in different orientations). As an example, the return to zero error in one probe orientation may be of the order of 25 μm in all directions; this can be thought of as defining a return to zero region or zone. The inset to FIG. 3 shows a rest position 48 of the stylus tip within the return to zero region 50.

The process of qualifying a suspended scanning probe has, prior to the present invention, simply involved using an arbitrary rest position adopted by the stylus (i.e. a rest position which may be located at any arbitrary position within the return to zero) to be the “null” position for that qualification. In a similar manner to a touch trigger probe, a mechanical clocking process can also be performed during qualification to try to align the stylus tip 46 with the spindle centre line. The null position of the scanning probe determined in such a way is then used as a reference point (i.e. a zero point or home position) in an analogous way to the rest position of a touch trigger probe. In other words, the null position set during qualification is used as the origin of the local probe coordinate system (e.g. the a=0, b=0, c=0 position) and all subsequent deflection measurements made by the probe transducers, along with any trigger or skip signals that might be generated in the touch trigger mode described below, are defined relative to that null position.

It should be noted here that a scanning probe may be used in a “scanning mode” in which a stream of probe deflection data (e.g. sets of a,b,c coordinate values) are generated during a scanning measurement in which the stylus is moved along a path on a surface of an object. A scanning probe system may, however, also be operated in a so-called “touch trigger mode” in which a trigger signal is issued when the magnitude of stylus deflection away from the null position exceeds a certain threshold. For example, a trigger signal may be issued when deflection exceeds the trigger threshold 52 shown in the inset to FIG. 3. Touch trigger mode allows the scanning probe to perform point-by-point touch trigger measurements of the type that can be acquired using a touch trigger probe thereby enabling the scanning probe to also be used in certain measurements cycles previously performed by a touch trigger probe. Touch trigger mode can also be used for part setup (e.g. prior to scanning a part).

As with a touch trigger probe, the qualification process for a scanning probe typically involves determining a probe offset whenever high accuracy metrology is required. For a scanning probe, the probe offset can be defined as the vector from the null position (i.e. the arbitrary null position determined as described above) to the axis of spindle rotation. After such a probe offset has been established, measurements can be performed in touch trigger mode or scanning mode that somehow take account of the probe offset. It is known, for example, to generate measurement cycles for running on the NC of a machine tool that make use of the measured probe offset. In particular, the probe offset vector can be applied to the position of each measuring move so that the probe ball contacts the desired target position on the object being measured. The probe offset can also be applied to the measured trigger position of the spindle centre line that is captured by the machine tool when the Triggered (SKIP) signal is raised. However, typical users of probing cycles will often program intermediate moves without taking the probe offset into account. This can lead to the measurement cycles having to add small moves to the toolpath prior to the measurement to correct for probe offsets. This has been found to lead to the machine tool juddering in certain instances, and also increases cycle time. Furthermore, it also means in practice that macros have to be called for even simple scan paths like straight line scans, in order to correct for the probe offset.

Although probe offset error values can be measured and incorporated into measurement programs running on the NC, some known probing cycles do not take account of the probe offset in this way. Instead, measurement routines can be implemented in which the effects of probe offset are eliminated. For example, the measurement probe may be rotated so that the same point (or the same arc for 3D systems) of the stylus always contacts with the part. If this scheme is used, a correction for the probe offset is combined with the correction for the “electronic radius” of the probe. Assuming that the probe offset is small and the contact position on the part is approximately correct the errors introduced by this technique are negligible. However, this adds to the complexity associated with programming a measurement cycle and can also add to the cycle time.

The present invention arises from the inventor recognising that the various problems associated with establishing or compensating for probe offset can be avoided when using a scanning probe, more particularly with a suspended scanning probe. As explained above, the present invention is based on the realisation that the probe offset effect may be substantially reduced or eliminated by adjusting the location of the probe null position so that it lies on the spindle centre line during the initial probe calibration (i.e. qualification or nulling) step. In other words, the arbitrarily selected null position used previously (i.e. based on the particular, arbitrary, rest position adopted by the stylus within the return to zero region during the calibration procedure) can be replaced by calculating and defining a null position that lies on the axis of rotation of the spindle. Various techniques that allow such a null position to be defined are described in more detail below.

Eliminating the probe offset as described herein has been found to simplify certain programming tasks to a point where a user could be expected to program the whole toolpath for a measurement without needing to use a macro program based approach. This has various advantages. For example, it allows probing moves to be programmed by the user without the need to add the probe offset to the programmed moves. This simplifies programming considerably, and eliminates the small moves that increase cycle time and cause juddering. Furthermore, it allows suspended probes that are not vertically mounted to be used with probing systems that rotate the probe rather than separately accounting for the probe offset; the only modification required to the cycles is to remove the spindle rotation commands.

The probe offset correction of the present invention is possible on scanning probes because, unlike touch trigger probes, the rest position is not precisely mechanically constrained but is instead a reference point chosen to lie within the range of positions that the stylus will return to when it is not in contact with a surface (i.e. the “return to zero region” mentioned above). In this example, the seated volume is larger than the adjustment that is required to the NULL position to place it onto the spindle centre line.

Referring to FIGS. 4 and 5, a technique for setting the null position of a suspended scanning probe to lie on the spindle centre line in accordance with the present invention will be described.

A first step comprises mechanically clocking the stylus as normal so that the rest position of the probe is as close as possible to the spindle centre line. This approximate mechanical alignment step means it can then be ensured that the spindle centre line position is not too far away from the return to zero region of the scanning probe.

A second step comprises mounting a conical calibration artefact to the bed of the machine tool. A conical artefact 90 having a conical recess 92 for receiving a stylus tip 94 is illustrated in FIG. 4. Although a conical feature is described, it should be noted that any feature type could be used that constrains movement the tip of the stylus probe in three dimensions but allows the stylus tip to rotate.

In a third step, the tip of the stylus is placed into the conical recess. The stylus tip is then maintained in a fixed location by the sides of the cone, but remains free to rotate within the cone. This step is performed after the cone has been roughly positioned on the spindle centre line, for example by measuring the outside of the cone artefact.

A fourth step comprises rotating the spindle and recording deflections of the stylus (i.e. probe deflection data or a, b, c coordinate values) at multiple spindle angles (e.g. 8 spindle orientations). The spindle angles may be measured angles (e.g. the machine tool may have encoders that measure the orientation of the spindle), nominal angles or commanded angles. It would also be possible to use assumed spindle position information (e.g. by assuming a stream of stylus deflections data corresponded to a certain amount of spindle rotation). A preliminary null position which lies on the stylus tip centre line is used as the basis for all such probe deflection measurements and this preliminary null position corresponds to the stylus rest position adopting during the clocking process. The use of such a preliminary null position enables probe measurements to be acquired in a common probe coordinate system. The probe deflection at a reference angular position of the spindle (i.e. at a rotation angle of zero in this example) also defines a zero rotation probe deflection value.

In a fifth step, the probe deflection data collected at the multiple spindle angles is analysed to estimate the positional deviation of the spindle centre line from the tip centre line. This is done using a least sum of squares fitting technique, although any suitable mathematical technique could be used. This process is described in more detail below.

In a sixth step, the location of the null position of the probe is adjusted by the positional deviation established in the fifth step. In other words, the preliminary null position is adjusted by a vector describing the positional deviation of the spindle centre line from the tip centre line (i.e. preliminary null) position. This provides a new null position that lies on the spindle centre line.

In an optional final step, the amount of adjustment required to move the preliminary null position to the new null position (i.e. the positional deviation value of the fifth step) is reported to the NC of the machine tool. This is done so that the machine tool can raise an error if it is found that the original mechanical clocking error was too large to be compensated for using this technique (e.g. because the new null position now lies too far away from the centre of the return to zero region).

Referring to FIG. 5 in more detail, there is shown the probe deflection data obtained when a scanning probe mounted to the spindle of a machine tool is rotated with its stylus tip retained in a conical feature as shown in FIG. 4. In particular, FIG. 5 shows how the conical feature can be considered to move in a circle about the spindle centre line S whilst the measurement probe remains stationary. The tip centre line T (i.e. on which the preliminary null position lies) then also remains stationary and separated from the spindle centre line S by a vector V. The cone position at 0° spindle rotation, as measured by the scanning probe, is illustrated as solid point 60a and this 0° position 60a is separated from the spindle centre line S by the vector R. The cone positions at the seven other spindle rotations (45°, 90°, 135°, 180°, 225°, 270° and 315° respectively) are illustrated by points 60b-60h.

The algorithm takes as inputs the probe data (e.g. a, b, c, deflection values) from each of the eight spindle orientations 64a-64h; these probe data describe the measured position of the stylus tip relative to the tip centre line (i.e. the preliminary null position) at the different spindle orientations. An iterative process is then performed in which the vector V (i.e. the vector to tip centre line position) and the vector R (i.e. the vector to the 0° cone position) are varied. This allows values of V and R to be found that best align the ends of the deflection vectors 64 with the eight rotated positions of the cone. It should be noted that the algorithm works in the frame of the spindle, meaning that as the spindle is rotated through the eight orientations, the data is modelled as it rotates within the fixed frame.

The vector V calculated from the iterative process can then be added to the preliminary null position or tip centre line T to define a new null position in the probe coordinate system that accurately lies on the spindle centre line S. The scanning probe system can then be updated so that all subsequent outputs in the local probe coordinate system are related to the new null position (i.e. so that all measurements are made relative to the spindle centre line). For example, the scanning probe may be configured to output stylus deflection values a=0, b=0 and c=0 when the stylus is in the new null position (i.e. when the stylus lies on the spindle centre line). Information relating to this new null position may then be stored within the scanning probe system (e.g. within the probe interface) such that all subsequent measurements are taken relative to the new null position that coincides with the spindle centre line.

The above described method is only one way of ensuring the null position coincides with the spindle centre line. Alternative techniques are also possible. For example, an artefact could be accurately located on the spindle centre line (e.g. by clocking). The scanning probe could then be used to measure the position of the artefact. It would then be possible to assume that the artefact clocking errors are negligible and therefore the measurement gives the probe offset thus enabling the location of the null position of the probe to be adjusted by the measured probe offset so that it lies on the spindle centre line. The skilled person would also be able to devise variants to the above techniques to achieve the same result.

It should be remembered that the above embodiments are merely examples of how the present invention could be implement. The skilled person reading the present specification would appreciate the various alternative techniques that could be employed. For example, the use of contact scanning probes having a deflectable stylus is described above but the invention could also be applied to non-contact (e.g. optical, inductive etc) scanning probes. Similarly, although suspended scanning probe are specifically mentioned the invention could also be applied to scanning probes that have a defined rest position. The use of three dimensional scanning probes is also described in detail herein, but the same principles could be applied to two-dimensional or even unidirectional scanning probes.

1. A method for setting a null position of a scanning probe mounted to a rotatable spindle of a machine tool, the method comprising the step of setting the null position using probe measurement data collected by the scanning probe when mounted to the spindle, wherein the set null position is arranged to be away from the rest position of the scanning probe and to substantially coincide with the axis of rotation of the spindle.

2. A method according to claim 1, wherein the scanning probe comprises a probe body and an elongate stylus that extends from the probe body, the stylus comprising a workpiece contacting tip.

3. A method according to claim 2, wherein the scanning probe comprises one or more transducers within the probe body that measure deflection of the stylus and output probe measurement data describing deflection of the stylus.

4. A method according to claim 2, wherein the scanning probe is a suspended scanning probe, the stylus being attached to the probe body via a suspension mechanism that comprises a plurality of counteracting spring elements that suspend the stylus in a floating rest position in the absence of an externally applied force and which allow movement of the stylus away from the floating rest position when an external force is applied to the stylus.

5. A method according to claim 2, wherein the step of setting the null measurement position comprises collecting probe measurement data whilst the stylus tip is in contact with an artefact that constrains translation of the tip but allows rotation of the tip.

6. A method according to claim 5, wherein the artefact comprises a conical recess, three balls or a corner cube.

7. A method according to claim 5, wherein the spindle is rotated whilst translation of the stylus tip is constrained by the calibration feature and probe measurement data is collected by the scanning probe that describes deflection of the stylus at a plurality of different spindle rotational positions.

8. A method according to claim 7, wherein the probe measurement data is analysed to establish a positional difference between the spindle axis of rotation and a preliminary null position used by the scanning probe when collecting the probe measurement data, the null position being set by applying the established positional difference to the preliminary null position.

9. A method according to claim 1, comprising the step of locating an artefact on the bed of the machine tool such that it lies on the axis of rotation of the spindle, using the scanning probe to measure the positon of the artefact and using the measured position of the artefact to set the null position of the scanning probe.

10. A method according to claim 1, comprising an initial step of mechanically adjusting the position of the scanning probe relative the spindle to approximately align the rest position of the scanning probe to the axis of rotation of the spindle.

11. A method according to claim 10, when the mechanical adjustment comprises using a dial test indicator to measure alignment of the scanning probe.

12. A method according to claim 1, wherein the scanning probe outputs all probe measurement data relative to a preliminary null position prior to the null position being set.

13. A method according to claim 1, comprising the step of generating a trigger signal when the measurement data collected by the scanning probe exceeds a threshold, wherein the threshold is based on deviation from the set null position.

14. Apparatus comprising a scanning probe mounted to the rotatable spindle of a machine tool, the null position of the scanning probe being arranged to coincide with the axis of rotation of the spindle.

15. An apparatus according to claim 14, wherein the scanning probe includes a memory for storing null position information.

16. (canceled)
